(19) United States
(12) Patent Application Publication
(10) Pub. No.: US 2009/0218798 A1
(43) Pub. Date: Sep. 3, 2009

(54) DUAL MODE INFLATABLE CURTAIN CUSHION

(75) Inventor: Brett Garner, South Weber, UT (US)

Correspondence Address: AUTOLIV ASP INC, 3350 AIRPORT ROAD, OGDEN, UT, 84405, US

(73) Assignee: Autoliv ASP, Inc., Ogden, UT (US)

(21) Appl. No.: 12/040,624

(22) Filed: Feb. 29, 2008

(51) Int. Cl. B60R 21/26

(52) U.S. Cl. 280/742

(57) ABSTRACT

An inflatable curtain cushion assembly for side deployment in a vehicle. The assembly has an inflator and an inflatable curtain cushion with two chambers, wherein the first chamber vents inflation gas more quickly than the second chamber.

### TECHNICAL FIELD

The present invention relates generally to the field of automotive protective systems. More specifically, the present invention relates to a system for selectively venting inflation gases from an inflatable curtain cushion.

### BRIEF DESCRIPTION OF THE DRAWINGS

Understanding that drawings depict only typical embodiments of the invention and are not therefore to be considered to be limiting of its scope, the invention will be described and explained with additional specificity and detail through the use of the accompanying drawings in which:

FIG. 1 is a side elevation view of one embodiment of an inflatable curtain cushion assembly mounted in a vehicle.

FIG. 2 is a side elevation view of the inflatable curtain cushion assembly of FIG. 1.

FIG. 3A is a cross-sectional view of the inflatable curtain cushion assembly of FIG. 1 during early deployment.

FIG. 3B is a cross-sectional view of the inflatable curtain cushion assembly of FIG. 1 during full deployment.

FIG. 3C is a cross-sectional view of the inflatable curtain cushion assembly of FIG. 1 during late deployment.

FIG. 4 is a side elevation view of another embodiment of an inflatable curtain cushion assembly mounted in a vehicle.

FIG. 5 is a side elevation view of another embodiment of an inflatable curtain cushion assembly.

### INDEX OF ELEMENTS IDENTIFIED IN THE DRAWINGS

10 vehicle
12 roof rail
15 instrument panel
20 A-pillar of vehicle
25 B-pillar of vehicle
30 C-pillar of vehicle
35 D-pillar of vehicle
100 inflatable curtain cushion assembly
110 inflatable curtain cushion
112 first side
113 void
114 second side
115 gas inlets
116 tethers
117 first chamber seam
118 second chamber seam
119 mounting tab
120 inflator
122 inflator tubes
130 first chamber
132 inflation cells
140 second chamber
150 one-way valve
10 vehicle
12 roof rail
15 instrument panel
20 A-pillar of vehicle
25 B-pillar of vehicle
30 C-pillar of vehicle
35 D-pillar of vehicle
400 inflatable curtain cushion assembly
410 inflatable curtain cushion
415 gas inlets
416 tethers
420 inflator
422 inflator tubes
430 first chamber
440 second chamber
450 one-way valve
460 vent
500 inflatable curtain cushion assembly
510 inflatable curtain cushion
515 gas inlet
516 tethers
520 inflator
522 inflator tubes
530 first chamber
540 second chamber
550 one-way valve
570 gas guide
572 junction

### DETAILED DESCRIPTION

Described below are embodiments of apparatus, methods, and systems for inflatable curtain venting. In the following description, numerous specific details are provided for a thorough understanding of the embodiments of the invention. However, those skilled in the art will recognize that the invention can be practiced without one or more of the specific details, or with other methods, components, materials, etc.

In addition, in some cases, well-known structures, materials, or operations are not shown or described in detail in order to avoid obscuring aspects of the invention. Furthermore, the described features, structures, or characteristics may be combined in any suitable manner in one or more embodiments.

Inflatable cushion systems are widely used to minimize occupant injury in a collision scenario. Cushion modules have been installed at various locations within a vehicle, including, but not limited to, the steering wheel, the instrument panel, within the side doors or side seats, adjacent to roof rail of the vehicle, in an overhead position, and at the knee or leg position. In the following disclosure, “airbag” may refer to an inflatable curtain airbag, overhead airbag, front airbag, or any other airbag type.

Inflatable curtain cushions typically extend longitudinally within the vehicle and are usually coupled to or next to the roof rail of the vehicle. In an undeployed state, inflatable curtain cushions are typically rolled, folded, or a combination of both, and retained in the undeployed configuration by wrapping at attachment points, or by being enclosed in a sock. In a deployed state, an inflatable curtain cushion may cover at least a portion of the side windows and the B-pillar of the vehicle. In some embodiments, inflatable curtain cushions may extend from the A-pillar to the C-pillar of the vehicle. In alternative embodiments, inflatable curtain cushions may extend from the A-pillar to the D-pillar of the vehicle.

In a collision event, the inflatable curtain cushion may be inflated by an inflator and changes conformation from rolled and/or folded to an extended deployed state. The amount of gas from the inflator that is retained within the inflatable curtain determines how hard or soft the cushioning of the curtain will be.

Inflatable curtain cushions may be configured to serve two functions: cushioning and anti-ejection. During a collision event, the curtain may cushion the head and upper body of an occupant, and during a roll-over event, the cushion may function to help retain the occupant within the vehicle. These two functions require significantly different time-scales. Typically, inflatable curtains are configured to provide cushioning during a side impact event for about 500 milliseconds. However, during a roll-over event, the inflatable curtain may need to cushion an occupant and protect against occupant ejection for up to seven seconds. Inflatable curtain cushions help mitigate the risk of occupant ejection by forming a barrier between the occupant and the side windows.

Inflation gas retention for an extended length of time, such as up to seven seconds, can be accomplished by manufacturing an inflatable curtain using high thread-count fabrics, sealed seams, and fabrics that have been coated with a substance that makes the fabric less porous to inflation gas. However, these manufacturing practices are more expensive than those required for gas retention for shorter lengths of time, such as less than 500 milliseconds.

It would be advantageous to provide an inflatable curtain cushion that could efficiently fulfill the dual functions of occupant cushioning and occupant retention without the high cost of manufacturing the entire inflatable curtain by more expensive practices. Embodiments disclosed below provide a reduced-cost dual mode inflatable curtain cushion that has an upper chamber configured to cushion an occupant for less than one second, and a lower section that may retain inflation gas for several seconds up to about seven seconds.

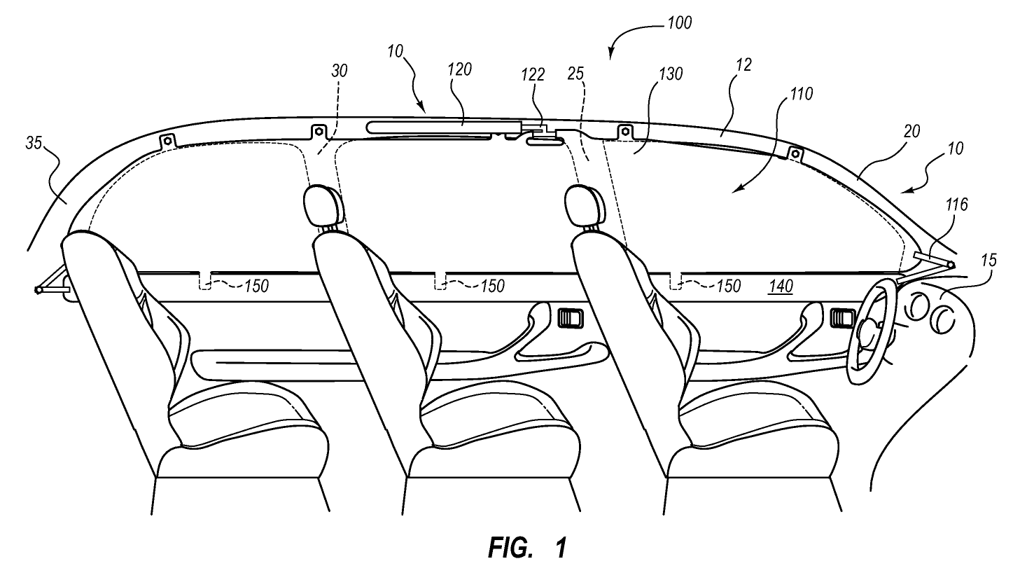

FIG. 1 represents one embodiment of an inflatable curtain cushion assembly 100 from a side elevation view, wherein assembly 100 is mounted inside a vehicle 10 adjacent a roof rail 12 and beside an instrument panel 15. Inflatable curtain cushion assembly 100 is depicted in a deployed state. Inflatable curtain cushion assembly 100 may comprise an inflatable curtain cushion 110 and an inflator 120.

Inflatable curtain cushion 110 may comprise two chambers, a first chamber 130 and a second chamber 140. The shape of inflatable curtain cushion 102 depicted in FIG. 1 is for illustrative purposes only, and may be altered. Inflatable curtain cushion 110 may be configured to fit within the side window wells of vehicle 10.

Inflatable curtain cushion 110 may comprise a contiguous piece of material manufactured using a one-piece woven technique or may be manufactured by cutting and sewing a nylon material, which is well known in the art. Curtain 110 comprises a first side and a second side of material, forming a void between them, into which inflation gas may be forced thereby inflating the curtain. First and second sides may be formed from a continuous sheet of material. Curtain 110 may be anchored to a vehicle structure via mounting tabs disposed on the outer edge of curtain 110 and by tethers 116. Tethers 116 may be coupled to curtain 110 by sewing, gluing, RF welding or by any other suitable manner. Further, tethers 116 may comprise extensions of curtain 110. Tethers 116 are anchored to a vehicle structure, such as A-pillar 20 and D-Pillar 35.

Inflator 120 is anchored to roof rail 12, and may be either a pyrotechnic device, or a stored gas inflator. Inflator 120, and may comprise inflator tubes 122, which act as conduits through which inflation gas travels from the inflator to the void formed by the two sides of inflatable curtain cushion 110. Inflator 120 is in electronic communication with vehicle sensors which are configured to detect vehicle collisions and rollovers; upon detection of predetermined conditions, the sensors activate the inflator and inflatable curtain cushion 110 is rapidly inflated.

First chamber 130 of inflatable curtain 110 runs substantially horizontally, with an upper edge of first chamber 130 running substantially parallel with and adjacent to roof rail 12 when curtain 110 is in the deployed configuration. First chamber 130 may comprise one or more inflation chambers, which may be of any shape; the rectangular inflation chambers depicted in FIG. 1 are for illustrative purposes only. First chamber 130 may not run the full horizontal length of curtain 110, and does not comprise the full vertical height of curtain 110.

In the embodiment of FIG. 1, second chamber 140 is formed from the same piece of material as first chamber 130, however, in other embodiments, second chamber 140 may be fabricated as a separate piece which is coupled to first chamber 130. Second chamber 140 is substantially horizontally oriented and is disposed below first chamber 130. Inflatable curtain 110 may have a configuration such that the bottom longitudinal edge of second chamber 140 may be disposed at or below the bottom of a side window in a vehicle.

A one-way valve is disposed between the first and second sides of first chamber 130 and enables second chamber 130 to be in fluid communication with first chamber 130, but not vice-versa. When inflation gas pressure is higher in first chamber 130, gas will flow through one-way valve 150 into second chamber 140, however one-way valve 150 is configured such that gas cannot back-flow into first chamber 130 from second chamber 140. One-way valve 150 may comprise a fabric, metal, or plastic valve and may comprise a non-mechanical or a mechanical valve.

During a collision or roll-over event, vehicle sensors may activate inflator 120 such that inflatable curtain cushion 110 changes conformation from a stored configuration to a deployed configuration. First chamber 130 is configured such that it may provide impact cushioning to an occupant for a short duration of time, such as about 500 milliseconds before it deflates to ambient air pressure. First chamber 130 is configured to cushion the upper body and head of an occupant and protect the occupant from striking a B-pillar 25 or a C-pillar, depending on the configuration of the vehicle in which the person is an occupant. In the event that an occupant strikes the inflatable curtain while inflated, first chamber 130 may soften the cushioning by rapidly venting inflation gas via vents in the membrane of the inflatable curtain, via unsealed seams, via the porosity of the material itself, or via a combination of the three.

Upon inflation, the length of second chamber 140 is necessarily shortened due to its circular shape; the shortening of second chamber 140 helps to tension inflatable curtain 110. Thus, second chamber 140 may help to mitigate the possibility of occupant ejection during a roll-over event by remaining inflated for up to seven seconds after inflation, and thereby maintaining the tautness of inflatable curtain 110. In this way, inflatable curtain 110 remains in place and properly positioned so that it may act as an effective barrier to occupant ejection through a side window. Further, second chamber 140 may cushion an occupant during a collision event or a roll-over event.

Thus, second chamber 140 is configured to retain inflation gas at a pressure higher than an ambient air pressure for a predetermined period of time, up to about seven seconds. The retention of inflation gas within second chamber 140 at a pressure higher than the ambient air pressure will at least partially maintain a tension on the curtain cushion such that it stays in place and acts as a barrier to occupant ejection.

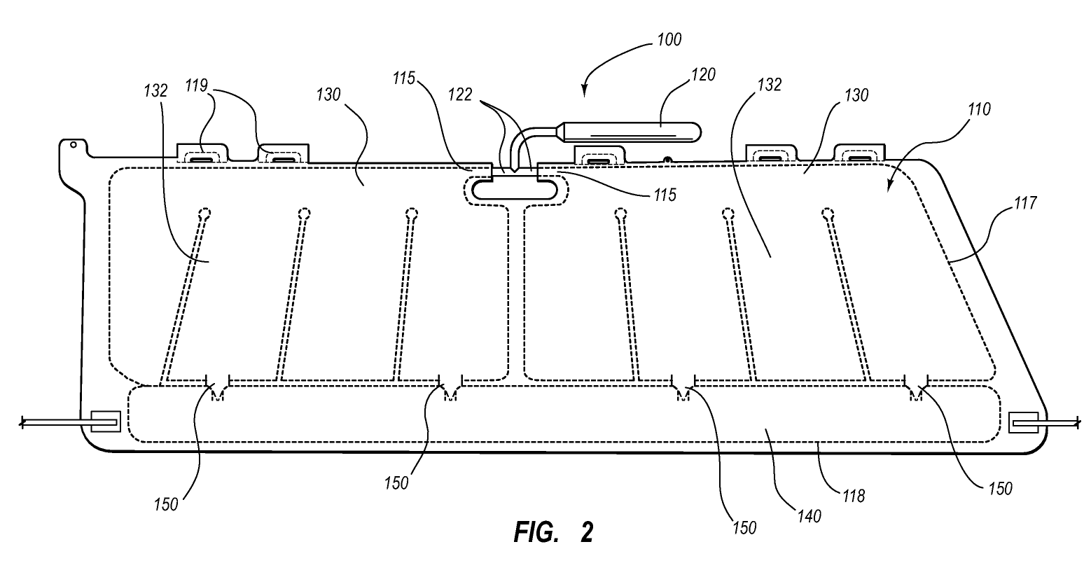

FIG. 2 depicts the inflatable curtain cushion assembly 100 of FIG. 1. More visible in this view are the gas inlets 115 of cushion 110, which receive inflation gas from inflator tubes 122 of inflator 120. Gas inlets 115 may comprise contiguous extensions of first chamber 130. First chamber seams 117 may comprise stitching that is not air-tight, or an air-tight seam generated via RF welding or gluing, or a combination of stitching and seam seals. First chamber seams 117 may form inflation cells 132, which are depicted as being rectangular, but may be of any shape. Typically, inflation cells 132 are contoured in accordance with a specific vehicle, such that cushion curtain 110 may offer better occupant protection. Left and right halves of first chamber 130 are depicted in FIG. 2 as being independent inflation cells, however, in alternative embodiments, first chamber 130 may comprise one inflation cell or at least two inflation cells in fluid communication.

Mounting tabs 119 may comprise extensions of curtain cushion 110, or may comprise separate pieces that are attached to curtain cushion 110. Mounting tabs are primarily positioned along the top edge of curtain cushion 110 such that the curtain cushion may be mounted along the roof rail of a vehicle.

Second chamber 140 is formed from the material comprising curtain cushion 110 by second chamber seam 118, which is depicted in FIG. 2 as being stitching. Seam 118 may comprise stitching that is not air-tight or air-tight stitching, further it may comprise an air-tight seam generated via RF welding or gluing, or a combination of stitching and seam seals. FIG. 2 depicts curtain cushion 110 as having four one-way valves 150, however, in alternative embodiments curtain cushion 110 may comprise one or more one-way valves.

One-way valves 150 are disposed in between the first and second sides of curtain cushion 110 and is also disposed between first chamber 130 and second chamber 140. One-way valves 150 are held in place via stitching, and are disposed into areas where first chamber seam 117 and second chamber seam 118 are interrupted. On either longitudinal side of one-way valves 150, first chamber seam 117 and second chamber seam 118 continue such that the only path by which inflation gas may travel between first chamber 130 and second chamber 140 is by one-way valves 150.

One-way valves 150 may comprise non-mechanical valves, such as pieces of fabric, or mechanical valves manufactured from plastic, metal, or a combination of fabric, plastic, or metal. Additionally, one-way valves 150 may be configured such that a predetermined magnitude of gas pressure is required in first chamber 130 before one-way valves 150 are opened and allow inflation gas to enter second chamber 140. Alternatively, one-way valves 150 may be configured such that inflation gas may freely travel from first chamber 130 to second chamber 140 whenever there is a greater magnitude of gas pressure in first chamber 130. Any conventional one-way valve may be used.

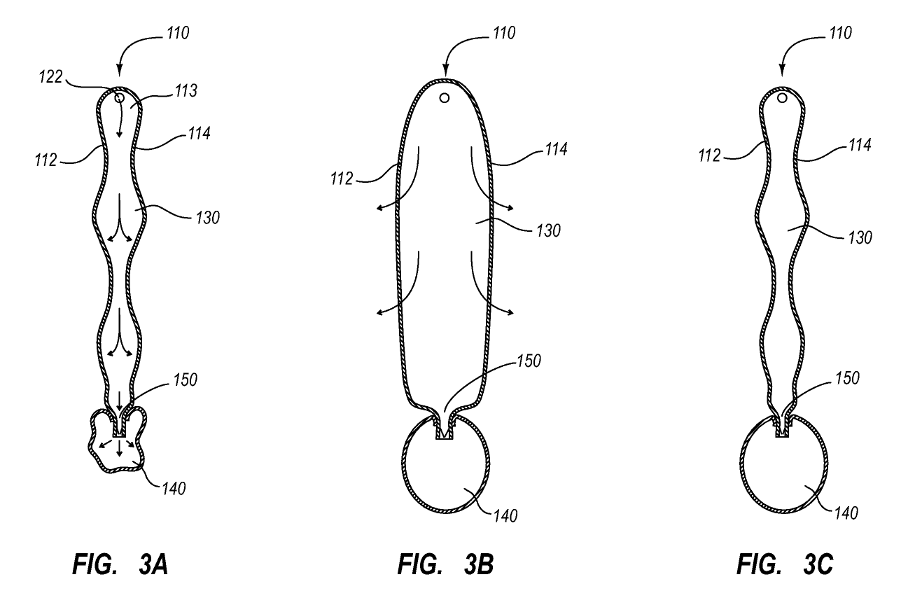

FIGS. 3A to 3C depict inflatable curtain cushion assembly 100 of FIG. 1 from a front elevation cross-sectional view during early deployment, full deployment, and late deployment, respectively. In FIG. 3A, inflation gas, (depicted as arrows) enters curtain cushion 110 via inflator tubes 122 and begins to fill a void 113 formed by first side 112 and second side 114. During early curtain cushion deployment, the magnitude of gas pressure in first chamber 130 may slightly exceed that of second chamber 140, even if one-way valve 150 does not require a predetermined pressure differential to allow gas transfer.

During full curtain cushion deployment depicted in FIG. 3B, first chamber 130 and second chamber 140 are inflated and comprise an pressure above an ambient air pressure and inflation gas may rapidly vent from first chamber 130 via discrete vents, unsealed seams, porosity of the material which comprises first chamber 130, or a combination of these causes. If an occupant strikes first chamber 130, additional inflation gas may be pushed into second chamber 140, however, due to one-way valve 150, inflation gas may not travel from second chamber 140 back to first chamber 130.

FIG. 3C depicts late curtain cushion deployment, wherein first chamber 130 has vented inflation gas such that first chamber 130 has returned to a pressure that is at or near ambient air pressure. Second chamber 140 remains inflated at a pressure above ambient air pressure and may remain inflated for an extended time period, such as up to seven seconds.

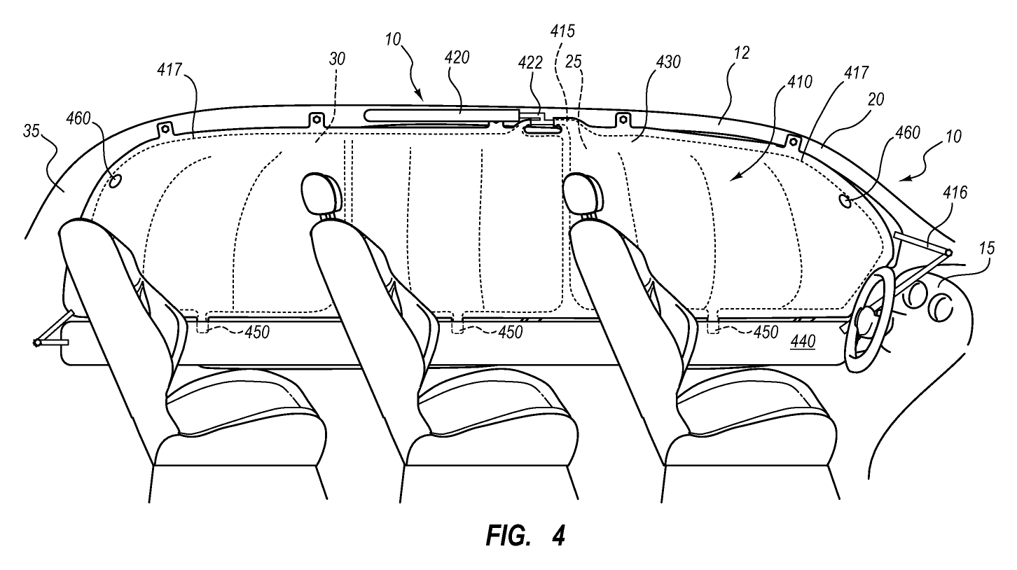

FIG. 4 is a side elevation view of another embodiment of an inflatable curtain cushion assembly 400. Inflatable curtain cushion assembly 400 is configured similarly and is configured to function similarly to cushion assembly 100, except the differences described below. Cushion assembly 400 is manufactured using a cut and sew technique, whereas cushion assembly 100 is manufactured using a one piece woven technique. Inflatable curtain cushion assembly 400 is mounted inside a vehicle 10 adjacent a roof rail 12 and beside an instrument panel 15. Inflatable curtain cushion assembly 400 is depicted in a deployed state and is anchored to an A-pillar 20 and a D-pillar 35 via tethers 416.

Since first chamber 430 is configured to vent inflation gas more rapidly, a cut and sew technique allows the first chamber 430 to be manufactured from a woven material with a thread count that is lower than the material from which second chamber 440 is manufactured. As first chamber 430 comprises a majority of the surface area of curtain cushion 410 and the lower thread count material is less expensive than the higher thread count material, this technique lowers the cost of manufacturing a curtain cushion such as the embodiment shown at 410. Additionally, curtain cushion 410 may be manufactured using a combination of one piece woven and cut and sew techniques, including by utilizing an integral sheet with sections having different thread counts.

First chamber 430 comprises two pieces of material which are sewn together (first chamber seam 417) to form a first side and a second side of first chamber 430. First chamber 430 further comprises vents 460, which are in fluid communication with a void formed by first and second sides of cushion 410 and are configured rapidly vent inflation gas. First chamber 430 receives inflation gas via gas inlets 415, which in turn, receives gas from inflator gas tubes 422. Inflator 420 is depicted as being mounted in the roof rail 12, however in alternative embodiments, inflator 420 (and other inflators described herein) may be disposed in other positions.

Second chamber 440 may be manufactured from one or two pieces of a woven material with a higher thread count than that of first chamber 430. Second chamber 440 does not touch first chamber 430, except at one-way valves 450; alternatively second chamber 440 may be sewn to first chamber 430. Additionally, second chamber 440 may be coupled to first chamber 430 via loops of material that are attached to first chamber 430 and encircle second chamber 440. First chamber 430 and second chamber 440 may be individually tethered to a vehicle structure, or they may be tethered together.

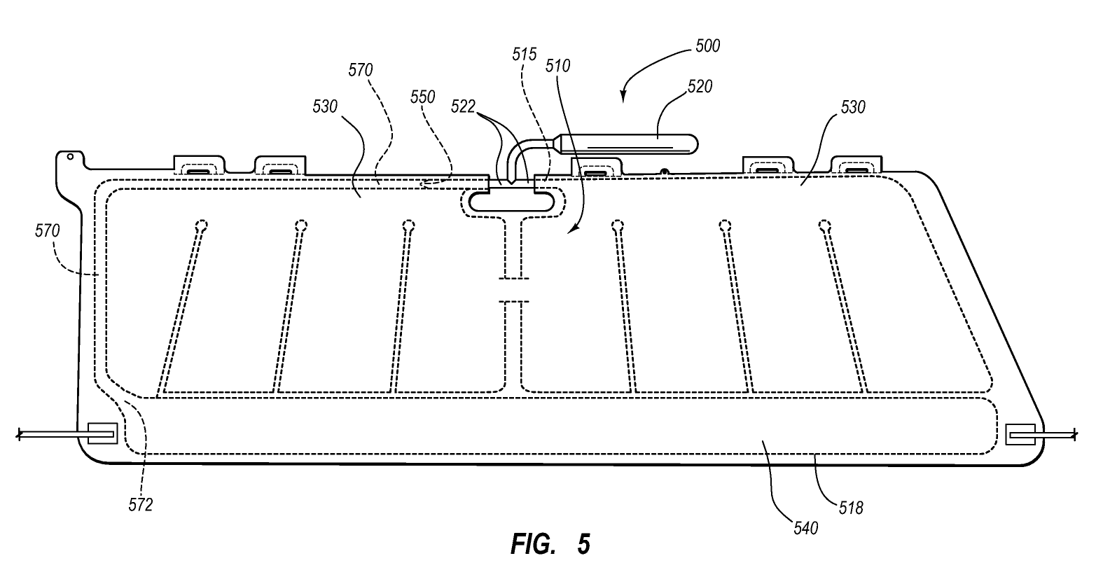

FIG. 5 is a side elevation view of another embodiment of an inflatable curtain cushion assembly 500, which is intended to function similarly to the above described curtain cushion assemblies, however the configuration of first chamber 530 and second chamber 540 differs from previously described curtain cushion assemblies. Curtain cushion 510 is depicted as comprising a single piece of material manufactured using a one piece woven technique, but may alternatively be manufactured using a cut and sew technique, wherein the first chamber 530 and second chamber 540 comprise different pieces of material. Additionally curtain 510 may be manufactured using a combination of one piece weaving, and cut and sew techniques.

First chamber 530 may comprise a gas inlet 515 which receives inflator tube 522 such that inflation gas from an inflator 520 may enter first chamber 530 via gas inlet 515. In other embodiments, gas inlet 515 may comprise a different shape and there may be more than one gas inlet 515 present to receive more than one inflator tube 522.

First chamber 530 is depicted has having multiple rectangular shaped inflation cells, however in alternative embodiments, the quantity, volume, and shape of inflation cells within first chamber 530 may vary. Additionally, first chamber 530 is depicted as having two gas inlets 515 which are integral extensions of first chamber 530 and are coupled to inflator tubes 522. In alternative embodiments, first chamber 530 may comprise less than two gas inlets 515. Thus, the inflation cells of first chamber 530 may not be supplied with inflation gas from two different gas inlets 515, and therefore may be more highly integrated and in greater fluid communication than depicted in FIG. 5.

Second chamber 540 may comprise a woven material with a thread count higher than the material from which first chamber 530 was manufactured. Alternatively, or in combination with the above, second chamber 540 may be more heavily coated than first chamber 530 with a sealing compound that blocks the apertures between the threads of the woven material from which the chambers are manufactured. Finally, second chamber 540 may be manufactured using techniques which result in air-tight seams 518, or second chamber 540 may be manufactured from a combination of the above techniques which, individually or in combination, may render second chamber 540 less porous to inflation gas.

Reducing the porosity of second chamber 540 may result in second chamber 540 remaining above a predetermined pressure for at least a predetermined time, which time is longer than the time at which first chamber 530 remains at a predetermined pressure. Thus, second chamber 540 may help inflatable curtain cushion 510 to remain taut during a roll-over event thusly making curtain cushion 510 a more effective barrier to occupant ejection.

Second chamber 540 is depicted in FIG. 5 as defining one large, horizontally oriented inflation cell. However the configuration of second chamber 540 depicted in FIG. 5 is strictly for illustrative purposes and in alternative embodiments, second chamber 540 may comprise multiple inflation cells that may or may not be substantially horizontally oriented.

Gas guide 570 may comprise a contiguous extension of second chamber 540, or may comprise a separate piece of material. Second chamber 540 receives inflation gas via gas guide 570, which in turn receives inflation gas from inflator tube 522. A one-way valve 550 is disposed between inflator 520 and second chamber 540. In the depiction of FIG. 5, one-way valve 550 is disposed very near inflator tube 522, however, one-way valve 550 may be disposed anywhere along gas guide 570, including at the junction 572 of gas guide 570 and second chamber 540. Thus, second chamber 540 is configured to retain inflation gas at a pressure higher than an ambient air pressure for a predetermined period of time, up to about seven seconds.

If an occupant strikes first chamber 530, inflation gas may be forced into second chamber 540 via one-way valve 550, thus increasing the gas pressure within second chamber 540. In this way, one-way valve may help to cushion the occupant by venting inflation gas from first chamber 530 to second chamber 540. Additionally, a higher gas pressure within second chamber 540 may allow curtain cushion 510 to remain a more effective barrier to occupant ejection for a longer period of time than if an occupant did not strike first chamber 530.

The methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Without further elaboration, it is believed that one skilled in the art can use the preceding description to utilize the invention to its fullest extent. The examples and embodiments disclosed herein are to be construed as merely illustrative and not a limitation of the scope of the present invention in any way. It will be apparent to those having skill in the art that changes may be made to the details of the above-described embodiments without departing from the underlying principles of the invention. In other words, various modifications and improvements of the embodiments specifically disclosed in the description above are within the scope of the appended claims. The scope of the invention is therefore defined by the following claims. Note also that elements recited in means-plus-function format are intended to be construed in accordance with 35 U.S.C. §112 ¶6.

1. An inflatable curtain cushion assembly for a vehicle comprising:
an inflatable curtain cushion comprising opposing sides which define a void, the inflatable curtain cushion inflatably coupled to an inflator, the inflatable curtain cushion comprising;
a first chamber configured to cushion an occupant in a vehicle upon deployment of the cushion, the first chamber configured to retain inflation gas at a pressure higher than an ambient air pressure for a first duration;
a second chamber disposed below the first chamber, configured to cushion an occupant upon deployment and keep the inflatable curtain taut, the second chamber configured to retain inflation gas at a pressure above an ambient air pressure for a second duration, which is greater than the first duration; and,
at least one one-way valve disposed between the inflator and the second chamber, the one-way valve configured to receive inflation gas from the inflator and allow the inflation gas to flow into the second chamber, but not flow from the second chamber back through the one-way valve.

2. The inflatable curtain cushion assembly of claim 1, wherein the first duration is about 500 milliseconds and the second duration is about seven seconds.

3. The inflatable curtain cushion assembly of claim 1, wherein the first chamber vents inflation gas via a vent, wherein the vent comprises an aperture in the membrane of the inflatable curtain cushion.

4. The inflatable curtain cushion assembly of claim 1, wherein the second chamber has sealed seams but the first chamber is devoid of sealed seams.

5. The inflatable curtain cushion assembly of claim 1, wherein the sides of the inflatable curtain cushion comprise a woven material and inflation gas escapes from the first chamber through the woven material.

6. The inflatable curtain cushion assembly of claim 1, wherein the inflation gas flows from the first chamber into the second chamber.

7. The inflatable curtain cushion assembly of claim 1, wherein the second chamber is coated with a coating which renders the second chamber less porous to inflation gas than the first chamber.

8. The inflatable curtain cushion assembly of claim 1, wherein the sides of the inflatable curtain cushion are a contiguous piece of material.

9. The inflatable curtain cushion assembly of claim 1, wherein the first chamber is defined by a different piece of material than the second chamber, and wherein the material which defines the first chamber has a lower thread count than the material which defines the second chamber.

10. The inflatable curtain cushion assembly of claim 8, wherein the second chamber is only attached to the first chamber at the at least one one-way valve.

11. An inflatable curtain cushion assembly for a vehicle comprising:
an inflator configured to generate inflation gas in response to predetermined conditions, the inflator in electronic communication with at least one vehicle sensor;
an inflatable curtain cushion comprising two opposing sides which define a void for receiving the inflation gas, wherein the sides each comprise a woven material, wherein the inflatable curtain cushion is connected to the inflator at a roof-rail proximal surface of the inflatable curtain cushion, the inflatable curtain cushion comprising,
a first chamber partially defined by a roof-rail proximal edge of the inflatable curtain cushion, wherein the first chamber is configured to be substantially longitudinally oriented with respect to the vehicle, the first chamber configured to receive inflation gas from the inflator via an at least one gas inlet which integrally extends from the first chamber, wherein the first chamber is configured to vent inflation gas such that inflation gas is retained within the first chamber at a pressure higher than an ambient air pressure for a duration of less than one second,
a second chamber comprising the majority of the volume of the inflatable curtain cushion, the second chamber disposed adjacent to the first chamber and in fluid communication with the first chamber, the second chamber configured to retain inflation gas at a pressure above an ambient air pressure for a duration of several seconds,
at least one one-way valve disposed between the first chamber and the second chamber, the at least one one-way valve also disposed between the two sides of the inflatable curtain cushion, the at least one one-way valve configured to receive inflation gas from the first chamber and allow the inflation gas to flow into the second chamber, the at least one one-way valve also configured to not allow inflation gas to flow from the second chamber to the first chamber.

12. The inflatable curtain cushion assembly of claim 11, wherein the second chamber is fully inflated after the first chamber is fully inflated.

13. The inflatable curtain cushion assembly of claim 11, wherein the inflator is disposed above the first chamber when the cushion assembly is mounted in a vehicle.

14. The inflatable curtain cushion assembly of claim 11, wherein the at least one one-way valve comprises a piece of fabric.

15. The inflatable curtain cushion assembly of claim 11, wherein the at least one one-way valve comprises a mechanical valve.

16. The inflatable curtain cushion assembly of claim 11, wherein the second chamber is configured retain inflation gas at a pressure above an ambient air pressure, and wherein the retention of inflation gas tensions the inflatable curtain cushion for up to seven seconds such that the inflatable curtain cushion continues to cover a set of side windows of a vehicle to act as a barrier to occupant ejection.

17. The inflatable curtain cushion assembly of claim 11, wherein the second chamber receives inflation gas directly from the inflator, and wherein the inflation gas does not travel through the first chamber to enter the second chamber.

18. An inflatable curtain cushion assembly for a vehicle comprising:
an inflator configured to generate inflation gas in response to predetermined conditions, the inflator in electronic communication with at least one vehicle sensor;
an inflatable curtain cushion comprising two opposing sides which define a void for receiving the inflation gas, wherein the sides each comprise a woven material, wherein the inflatable curtain cushion is connected to the inflator at a roof-rail proximal surface of the cushion, the inflatable curtain cushion comprising,
a first chamber configured to be substantially longitudinally oriented with respect to a vehicle, wherein the first chamber is at least partially defined by the roof-rail proximal edge of the inflatable curtain cushion, the first chamber also configured to receive inflation gas from the inflator via an at least one gas inlet, which integrally extends from the first chamber, wherein the first chamber is configured to vent inflation gas such that inflation gas is retained within the first chamber at a pressure higher than an ambient air pressure for a duration of less than one second,
a second chamber disposed adjacent to the first chamber, wherein the second chamber comprises the majority of the volume of the inflatable curtain cushion, wherein the second chamber is in fluid communication with the inflator, wherein the second chamber is configured to retain inflation gas at a pressure above an ambient air pressure for a duration of several seconds,
a substantially air-tight gas guide configured to allow gas to flow from the inflator to the second chamber, the gas guide forming a continuation of the second chamber such that the gas guide is in fluid communication with the inflator and the second chamber,
at least one one-way valve disposed within the gas guide between the inflator and the second chamber, wherein the one-way valve is disposed between the two sides of the inflatable curtain cushion, the one-way valve configured to receive inflation gas from the inflator and allow the inflation gas to flow into the second chamber, the one-way valve also configured to not allow inflation gas to flow from the second chamber to the first chamber.

19. The inflatable curtain cushion assembly of claim 18, wherein the gas guide at least partially surrounds the first chamber on at least two sides.

20. The inflatable curtain cushion assembly of claim 18, wherein the second chamber is configured to tension the inflatable curtain cushion for up to seven seconds such that the inflatable curtain cushion continues to cover a set of side windows of a vehicle to act as a barrier to occupant ejection.

21. The inflatable curtain cushion assembly of claim 18, wherein the one-way valve is disposed within the gas guide nearer the inflator than the second chamber.

22. The inflatable curtain cushion assembly of claim 18, wherein the at least one one-way valve is disposed at the junction of the gas guide and the second chamber.

23. The inflatable curtain cushion assembly of claim 18, wherein the at least one one-way valve comprises a piece of fabric.

24. The inflatable curtain cushion assembly of claim 18, wherein the at least one one-way valve comprises a mechanical valve.

25. The inflatable curtain cushion assembly of claim 18, wherein the second chamber is filled with inflation gas at the same time as the first chamber.
